(19) United States
(12) Patent Application Publication
(10) Pub. No.: US 2006/0092773 A1
(43) Pub. Date: May 4, 2006

(54) Media device with retractable earpiece

(76) Inventors: Ancle Ann Keh Hsu, (US); Stephen R. Brothers, (US)

Correspondence Address: James C. Tran, 301 Brea Canyon Rd., Walnut, CA, 91789, US

(21) Appl. No.: 11/267,443

(22) Filed: Nov. 4, 2005

Related U.S. Application Data
(60) Provisional application No. 60/625,698, filed on Nov. 4, 2004.

(51) Int. Cl. G11B 21/08

(52) U.S. Cl. 369/30.01

(57) ABSTRACT

A media device includes a media player and an earpiece attached to the media player by an electric cord. The media player can be configured to play one or various audio media sources and/or formats, such MP3's and the like. The media player includes an audio signal generating module for generating an audio signal. The earpiece is operatively coupled to the audio signal generating module by the electric cord, which is connected at a first end to the audio signal generating module and at a second end to the earpiece. The media player also includes a retracting mechanism, which is configured to permit retraction of a desired portion of the electric cord into the media player.

### CROSS REFERENCE TO RELATED APPLICATIONS

The present application claims benefit of U.S. Provisional Application No. 60/625,698, filed on Nov. 4, 2004.

### FIELD OF THE INVENTION

The present invention relates to media devices and, more particularly, to media devices having retractable earpiece.

### BACKGROUND OF THE INVENTION

Media devices, particularly portable media players, are becoming increasingly popular. Such media devices may be configured to play one or various types of media sources and/or media formats including, for example, MP3 audio files, DVD's, compact discs, video files, and the like.

With most portable media players, the audio signal is outputted through a headset having earpieces which the user places adjacent to the user's ear in order to listen to the outputted sound. As is well known in the art, a typical headset consists of an electrical cord with the earpieces, or similar sound producing components, at a one end while the other end is inserted into the media player's headset jack. The cord's length is determined at the time of manufacture and is normally selected by the manufacturer for convenient operation of the media player and headset by the user.

However, because the length of the cord is predetermined, various shortcomings are encountered, due to the invariability of the cord's length and the personal preference and needs of each user. For example, a cord that is too short would interfere with the user's movement, while a cord that is too long would be prone to snagging onto nearby objects. The user has no option to adjust the length of the cord to suit the user's personal preference. Further, the cord is also susceptible to tangling, since there is no convenient means to store it when not being utilized. Another drawback with current media player/headset designs is that the headset may be misplaced and lost when not utilized or when not plugged into the media player.

There is thus a need in the art for a media device having a retractable earpiece.

### SUMMARY OF THE INVENTION

The present invention is directed to a media device with retractable earpiece. The invention overcomes shortcomings associated with media devices having headsets with electric cords of predetermined lengths when plugged into a media player's headset jack.

In one embodiment of the present invention, a media device includes a media player and an earpiece attached to the media player by an electric cord of a certain length. The media player can be configured to play one or various audio media sources and/or formats, such MP3's, compact discs, and the like. The media player includes an audio signal generating module for generating an audio signal. The earpiece is operatively coupled to the audio signal generating module by the electric cord, which is connected at a first end to the audio signal generating module and at a second end to the earpiece.

In such a configuration, the audio signal generating module can generate an audio signal, for example an audio signal derived from an MP3 file stored in the media player's memory component. The audio signal can travel from the audio signal generating module along the electric cord to the earpiece where it is converted to sound in a manner known in the art. The media player of the present embodiment also includes a retracting mechanism, which is configured to permit retraction of a desired portion of the electric cord into the media player. In this manner, the user is able to determine the length of the electric cord extending outside the media player so as to optimize the user's enjoyment of the media device.

In one embodiment, the retracting mechanism includes a spool around which the retracted portion of the electric cord is wound. The retracting mechanism can be of a spring loaded type. Alternatively, the retracting mechanism can a manually operated wheel for winding the retracted portion of the cord around the spool.

### BRIEF DESCRIPTION OF THE DRAWINGS

FIG. 1 is a block diagram of an exemplary embodiment of a media device in accordance with the present disclosure;

FIG. 2 is a block diagram of an exemplary embodiment of a media device in accordance with the present disclosure; and

FIG. 3 is a block diagram of an exemplary embodiment of a media device in accordance with the present disclosure.

### DETAILED DESCRIPTION OF THE INVENTION

The present invention is directed to a media device with retractable earpiece. The following description contains specific information pertaining to the implementation of the present invention. One skilled in the art will recognize that the present invention may be implemented in a manner different from that specifically discussed in the present application. Moreover, some of the specific details of the invention are not discussed in order to not obscure the invention. The specific details not described in the present application are within the knowledge of a person of ordinary skill in the art.

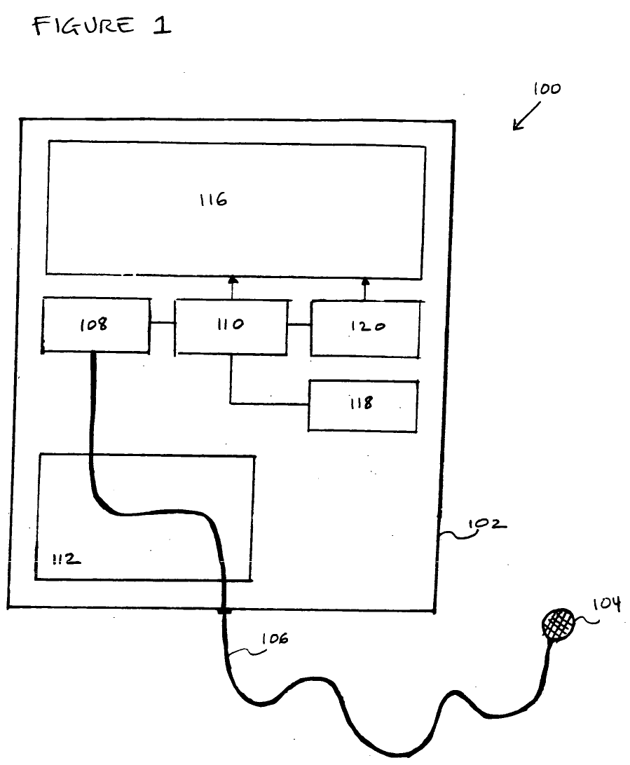

FIG. 1 illustrates a media device in accordance with one embodiment of the present invention. Device 100 comprises media player 102, with its various components which will be discussed in greater detail below, earpiece 104 and electric cord 106.

In the present embodiment, media player 102 is configured to play and/or process audio media and/or digital files, such as MP3, audio CD, audio cassette, and other comparable audio media/digital files, to derive an audio signal. As is known in the art, audio digital files can also be retrievably stored in a suitable memory component of media player 102.

Media player 102 may also include video functionality, for example the capability to play or process DVD, video files, and/or other comparable video media/formats. For example, video signal generating module 120 can be configured to process a video medium, such as a DVD, to derive a video signal. Such playback functionalities are well known in the art. It is appreciated that media player 102 can be other types of electronic devices capable of generating an audio signal for sound reproduction by an earpiece.

Media player 102 may include screen 116 for displaying information or the like for viewing by a person using media player 102. Screen 116 may also be enabled to display video, such as that derived from a DVD or other video media/formats. Further, media player 102 may include user interface module 118 for allowing the user to interact with media player 102. For example, user interface module 118 can comprise a set of keypads whereby the user can control media player 102, including controlling common features such as “play”, “stop”, “forward” and “reverse”, and “volume”. Other interface fuctionality can be included as desired.

As shown, media player 102 is operatively coupled to earpiece 104 by electric cord 106. A first end of cord 106 is connected to media player 102's audio signal generating module 108, and a second end of cord 106 is connected to earpiece 104. Audio signal generating module 108 is a component of media player 102 that is enabled to generate an audio signal derived from the audio media/digital format played or processed by media player 102 in a manner known in the art. For illustrative purposes, when media player 102 processes a digital file, such as an MP3 file stored in media player 102's hard drive (not shown), processor 110 can retrieve and decode the file and transmit the decoded bitstream to audio signal generating module 108, which can convert the decoded bitstream into an audio signal in a manner known in the art.

Audio signal generating module 108 can then transmit the generated audio signal via cord 106 to earpiece 104, where the audio signal is converted to sound. It is understood that media player 102 may process different audio media/digital formats differently, depending on the medium or format, and that such processing techniques are known to those of skill in the art and would similarly result in production of an audio signal derived from the particular medium or format. It is further understood that earpiece 104 refers to any device capable of converting the audio signal from audio signal generating module 108 into sound, including, for example, devices referred to commonly as ear buds, earphones, or headphones.

The length of cord 106, when fully extended, is preferred to be at least sufficient to allow earpiece 104 to be used comfortably by a person using device 100 such that, for example, there is some slack for the user to freely move the user's head without also jerking media player 102. As discussed in greater detail below, media player 102 also includes retracting mechanism 112 for controlling the length of cord 106 extending from media player 102.

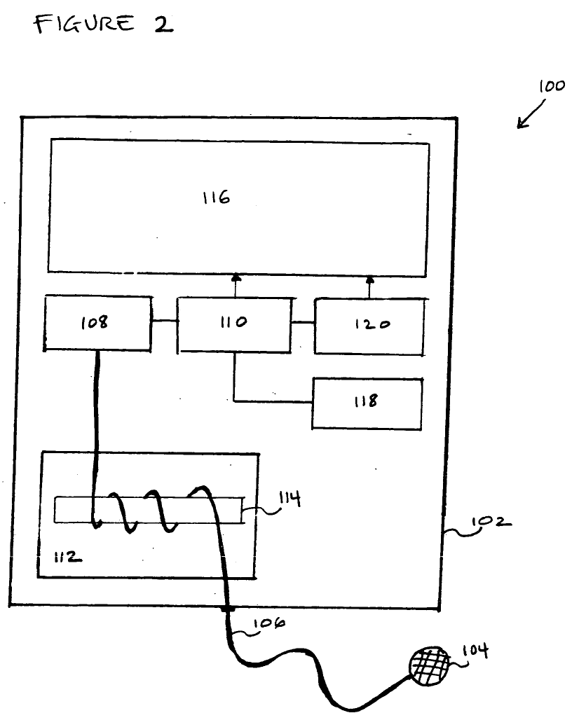

As illustrated in FIG. 2, retracting mechanism 112 permits retraction of a portion of cord 106 into media player 102. In one embodiment, retracting mechanism 112 can be of the spring loading type configured to recoil and wind cord 106 around spool 114 situated inside media player 102. In another embodiment, retracting mechanism 112 can be a manually powered mechanism, such as by way of a hand operated wheel, for winding cord 106 around spool 114. In a further embodiment, retracting mechanism 112 is an electrically powered mechanism which has a motor for winding cord 106 around spool 114. It is appreciated that a user can increase the length of cord 106 extending from media player 102 by, for example, grasping earpiece 104 and pulling earpiece 104 away from media player 102.

In a preferred embodiment, retracting mechanism 112 can be controlled by the operator to determine the amount of cord 106 that is wound around spool 114, thereby determining the length of cord 106 which remains unwound and extending out of media player 102. In this manner, the operator is able to control the amount of slack in cord 106 between media player 102 and earpiece 104, allowing for more convenient and comfortable use of device 100. The means by which the operator may control retracting mechanism 112 can be, for example, a user interface mechanism such as a button that operates the spring action of retracting mechanism 112.

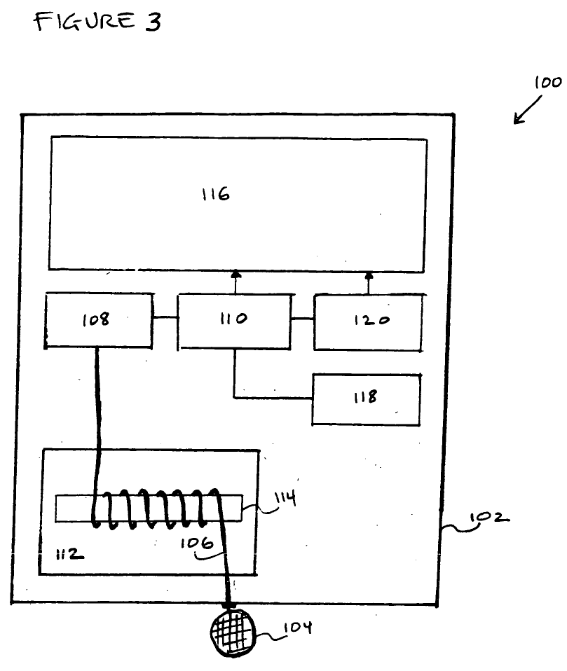

Further, as illustrated in FIG. 3, the operator can use retracting mechanism 112 to recoil and wind a substantial portion of cord 106 around spool 114 so as to minimize the length of cord 106 extending from media player 102 and thereby bring earpiece 104 next to media player 102. FIG. 3 shows a substantial portion of cord 106 wound around spool 114 and earpiece 104 brought relatively closer to media player 102.

The ability to wind a substantial portion of cord 106 around spool 114, as shown in FIG. 3, is desirable when the operator is not using media player 102 and wants to reduce the potential for damaging earpiece 104 and cord 106. For example, the likelihood for tangling cord 106 is lessened significantly. Also, with a substantial portion of cord 106 wound around spool 114, device 100 becomes more convenient to transport. This feature is advantageous for carrying portable media devices when not in use.

In one embodiment, the device of the present invention includes means for attaching the earpiece to the body of the media player such that the earpiece is prevented from dangling around, thereby reducing the likelihood of damaging the earpiece when not in use. For example, media player 102 can include a notch into which earpiece 104 can be snugly inserted and held in place by friction or pressure. This embodiment can be further enhanced by specifying the fit between earpiece 104 and the notch on media player 102 to be such that an audible “click” or similar sound is made when earpiece 104 is properly inserted into the notch. In this manner, the proper attachment of earpiece 104 to media player 102 is confirmed. As another example, earpiece 104 can be attached to the body of media player 102 using a snap button-like configuration, wherein an indentation in earpiece 104 is snapped onto a corresponding nipple on the body of media player 102. As further examples, earpiece 104 can be attached to media player 102 magnetically or by Velcro.

In another embodiment, the device of the present invention includes an electric cord that is connected by a first end to the media player's audio signal generating module. In this embodiment, the second end of the cord is split into two lines, with each line being attached to a separate earpiece, for example a “left” and a “right” earpiece. As is known in the art, such a configuration is necessary for stereophonic audio signals.

In another embodiment, the device of the present invention is a radio having a receiver for receiving radio broadcasts. The receiver can send the received signal to an audio signal generating module which generates an audio signal transmitted along an electric cord to an earpiece. In this embodiment, the device also includes a cord retracting mechanism, such as retracting mechanism 112 of FIG. 1, for controlling the length of the electric cord extending from the device.

While various embodiments of the present invention have been shown and described above, it should be understood that they have been presented by way of example only and not limitation. Many other embodiments are possible, without departing from the spirit and scope of the invention. Thus, the breadth and scope of the present invention should not be limited by any of the above-described exemplary embodiments.

What we claim is:

1. A media device comprising:
a media player having an audio signal generating module and a retracting mechanism;
an earpiece; and
an electric cord having a length, said electric cord being connected at a first end to said audio signal generating module and at a second end to said earpiece so as to operatively couple said earpiece to said audio signal generating module;
wherein said retracting mechanism is configured to permit retraction of a desired portion of said length of said electric cord into said media player so as to determine the amount of said length of said electric cord extending outside said media player.

2. The media device of claim 1 wherein said retracting mechanism comprises a spool and said desired portion of said cord is wound around said spool.

3. The media device of claim 1 wherein said retracting mechanism is of a spring loading type configured to recoil and wind said desired portion of said electric cord around a spool of said retracting mechanism.

4. The media device of claim 1 wherein said retracting mechanism comprises a hand operated wheel for winding said desired portion of said electric cord around a spool of said retracting mechanism.

5. The media device of claim 1 wherein said desired portion of said electric cord is substantially equal to said length of said electric cord.

6. The media device of claim 1 wherein said media player includes means for attaching said earpiece to said media player.

7. The media device of claim 1 wherein said media player further comprises a notch wherein said earpiece can be snugly inserted.

8. The media device of claim 1 wherein said earpiece is attached to the body of said media player by Velcro.

9. The media device of claim 1 wherein said earpiece is attached to the body of said media player by magnets.

10. A media device comprising:
a media player having an audio signal generating module;
an electric cord operatively coupling an earpiece to said audio signal generating module; and
a retracting mechanism situated inside said media player configured to retract a desired portion of said electric cord into said media player.

11. The media device of claim 10 wherein said earpiece is situated externally to said media player.

12. The media device of claim 10 wherein said electric cord is connected at a first end to said audio signal generating module and at a second end to said earpiece.

13. The media device of claim 10 wherein said retracting mechanism comprises a spool and said desired portion of said cord is wound around said spool.

14. The media device of claim 10 wherein said retracting mechanism is of a spring loading type configured to recoil and wind said desired portion of said electric cord around a spool of said retracting mechanism.

15. The media device of claim 10 wherein said retracting mechanism comprises a hand operated wheel for winding said desired portion of said electric cord around a spool of said retracting mechanism.

16. The media device of claim 10 wherein said desired portion of said electric cord is substantially equal to said length of said electric cord.

17. The media device of claim 10 wherein said media player includes means for attaching said earpiece to said media player.

18. The media device of claim 10 wherein said media player further comprises a notch wherein said earpiece can be snugly inserted.

19. The media device of claim 10 wherein said earpiece is attached to the body of said media player by Velcro.

20. The media device of claim 10 wherein said earpiece is attached to the body of said media player by magnets.
